(19) United States
(12) Patent Application Publication
(10) Pub. No.: US 2026/0286201 A1
(43) Pub. Date: Sep. 24, 2026

(54) SYSTEM AND A METHOD FOR CATIONIZATION OF ABRASIVE PARTICLES

(71) Applicant: FUJIMI INCORPORATED, Kiyosu-shi (JP)

(72) Inventor: Jimmy Granstrom, Tualatin, OR (US)

(21) Appl. No.: 19/566,898

(22) Filed: Mar. 13, 2026

Related U.S. Application Data
(60) Provisional application No. 63/775,199, filed on Mar. 20, 2025.

(51) Int. Cl. C09K 3/14

(52) U.S. Cl. CPC C09K 3/1436

(57) ABSTRACT

To provide systems and methods for cationization of abrasive particles. Systems and methods are provided for a polishing composition comprising polishing abrasive particles, and a water soluble metal salt, wherein the metal cation of the water soluble metal salt is hydrolyzed at a pH greater than or equal to seven without forming a precipitate.

### CROSS-REFERENCE TO RELATED APPLICATIONS

The present application claims priority to U.S. Provisional Application No. 63/755,199 entitled “SYSTEMS AND METHOD FOR CATIONIZATION OF ABRASIVE PARTICLES”, filed on Mar. 20, 2025. The entire contents of the above listed application is hereby incorporated by reference for all purposes.

### FIELD

The present description relates generally to compositions and preparation methods for cationized abrasive particles.

### BACKGROUND/SUMMARY

Chemical mechanical planarization (CMP) is a process used in fabrication of nano and microelectronics. A polishing composition reacts chemically and physically with a substrate being planarized to facilitate removal of the substrate material. For example, abrasive particles, such as silicon dioxide particles, may be included in a CMP polishing composition to help physically wear away the substrate material. In such examples, it is beneficial for a surface charge of the abrasive particles to be opposite a surface charge of the substrate material, thereby promoting attraction between the abrasive particles and the substrate material.

However, a surface charge of the abrasive and substrate material are both pH sensitive and conventional functionalization of abrasive particles provides a cationic charge when a pH of the polishing composition is acidic and not when the pH is neutral or basic. For some applications, it is desirable to provide a neutral or basic polishing composition where the substrate material is negatively charged and abrasive particles are positively charged.

In one example, the issues described above are recognized by the inventors and may be at least partially addressed by a polishing composition comprising a polishing abrasive particle, a water soluble metal salt, wherein a metal cation of the water soluble metal salt is hydrolyzed at a pH≥7 without forming a precipitate. A surface of the polishing abrasive particle of the polishing composition may be positively charged at a pH greater than or equal to seven, as measured by a positive zeta potential, while a substrate being polished may have a neutral or negative surface charge. In this way, a polishing rate per amount of abrasive added to the polishing composition may be increased due to increased attraction between the polishing abrasive particle and the substrate. By decreasing an amount of demanded abrasive for achieving a desired polishing rate, an overall cost of the CMP process may be decreased.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a diagram of a chemical mechanical planarization (CMP) system and a polishing composition.

FIG. 2 shows an example of a diagram when polishing abrasive particles are functionalized with metal hydroxide.

FIG. 3 shows a plot of metal species distribution as a function of pH.

FIG. 4 shows a plot of zeta potential as function of pH for abrasive particles with and without metal salt.

FIG. 5 shows a flow chart of an example of a method for preparing a colloidal suspension of the metal cation functionalized polishing abrasive particles.

### DETAILED DESCRIPTION

Hereinafter, the invention is described in detail. Herein, “X to Y” is used to mean that numerical values (X and Y) described before and after “to” are included as the lower limit value and the upper limit value, and means “X or greater and Y or less”. In a case where plural descriptions are made with respect to “X to Y” and “X or greater and Y or less”, for example, “X1 to Y1, or X2 to Y2”, or “X1 or greater and Y1 or less, or X2 or greater and Y2 or less” is described, all of the disclosure where each numerical value is adopted as the upper limit, the disclosure where each numerical value is adopted as the lower limit, and the disclosure of any combination of such upper limit and lower limit are made (namely, these disclosures serve as legitimate bases for amendments). Specifically, all of respective amendments to X1 or greater, Y2 or less, X1 or less, Y2 or greater, X1 to X2, X1 to Y2, and the like need to be regarded as legitimate. Unless particularly noted, operations, and measurement of physical properties and the like are made under conditions of room temperature (20 to 25° C.) and a relative humidity of 40 to 50% RH. The concentration described herein may be a concentration at POU (Point-of-use) or a concentration before dilution to the concentration at POU. The dilution factor may be 2 to 10-fold. It is to be understood that all combinations of embodiments and descriptions disclosed herein are disclosed in this application. In other words, it is to be understood that these combinations may serve as legitimate bases for amendments. In a case where the content or the concentration of each component is described and two or more kinds of such components are included, the total amount of such components may be adopted. Furthermore, in a case where a feature or an aspect of the disclosure is described in terms of the Markush group, those skilled in the art will recognize that the disclosure is thus described in terms of any individual constituent component or a subgroup of constituent components in the Markush group. The description relating to a mechanism disclosed herein is a matter for speculation and it goes without saying that the scope of protection of the invention is not limited by this mechanism.

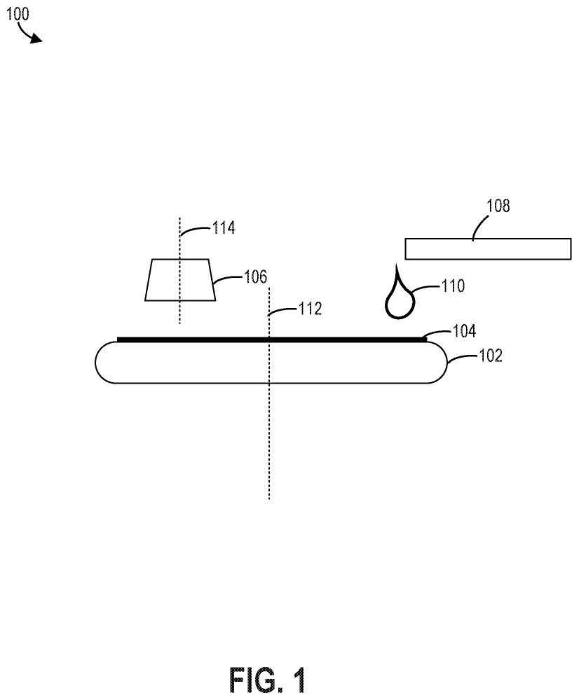

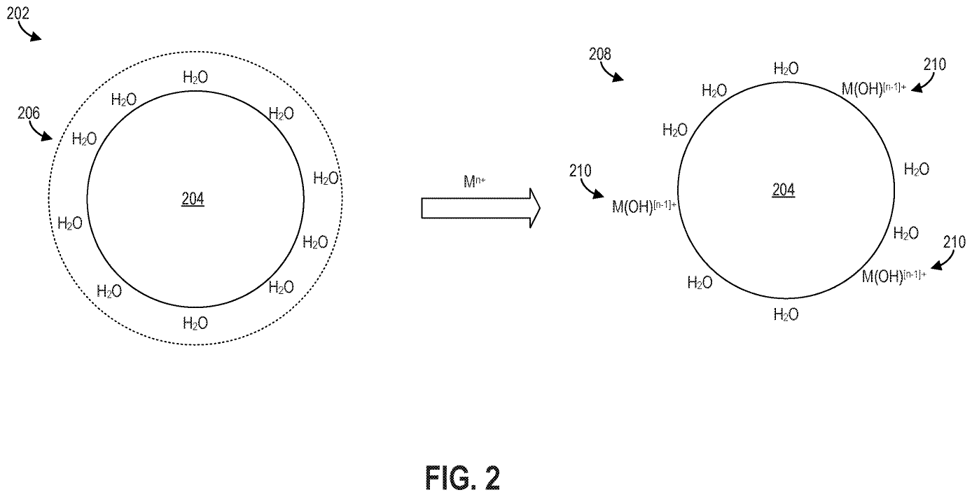

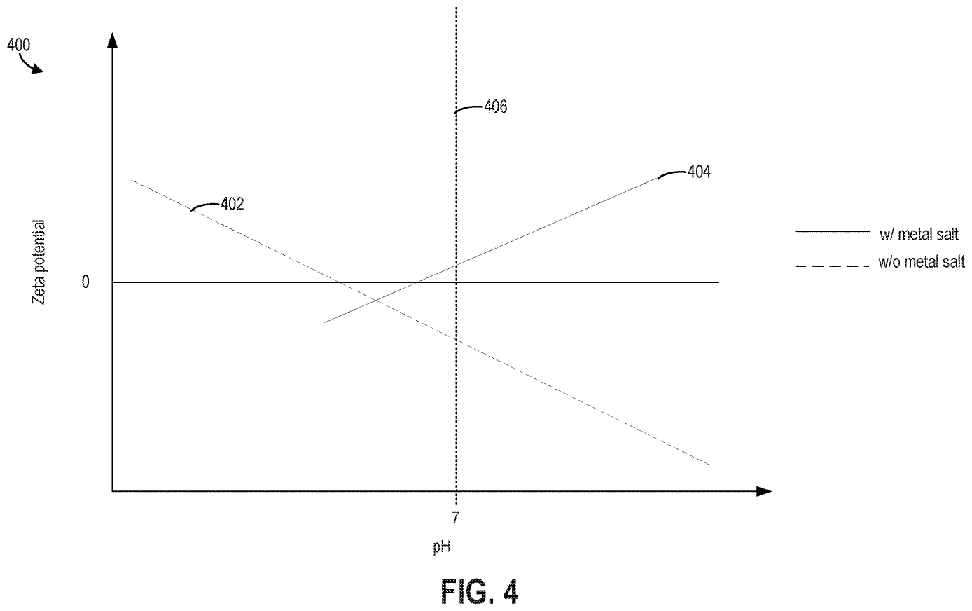

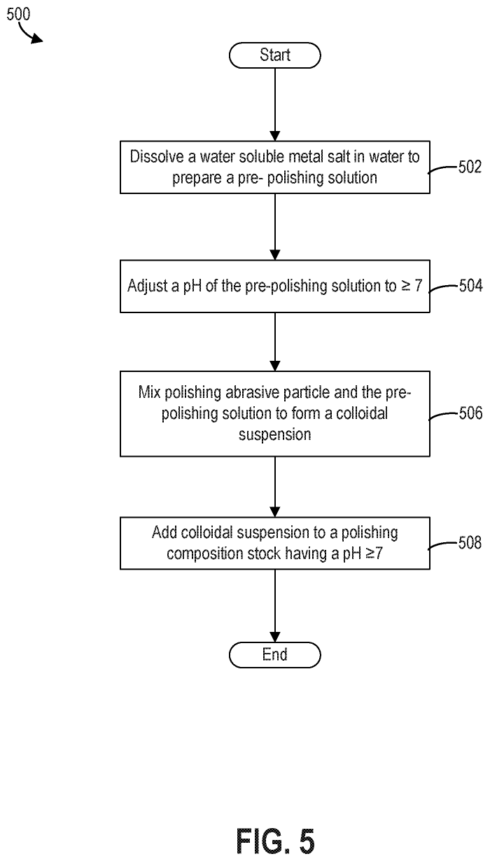

The following description relates to systems and methods for cationization of polishing abrasive particles. Polishing abrasive particles may be included in a polishing composition used in a chemical mechanical planarization (CMP) system, such as the CMP system diagramed in FIG. 1. A sphere of hydration may form on a polishing abrasive particle when the polishing abrasive particle is in an aqueous polishing composition. Functionalizing a surface of the polishing abrasive particle demands overcoming the energy barrier demanded to break the sphere of hydration. Metal hydroxides may be particularly suited to disrupting the sphere of hydration around the silica (SiO₂, silicon dioxide) particle as shown in FIG. 2. For this reason, metal salts may be used for cationization of a polishing abrasive particle. Effective cationization may be measured as a positive zeta potential of the polishing abrasive particle. FIG. 4 shows a graph of zeta potential as a function of pH for colloidal suspensions of polishing abrasive compounds with and without a metal salt present. A flow chart of a method for preparing a colloidal suspension for a polishing composition including the polishing abrasive compound and metal salt is shown in FIG. 5.

Briefly, an example of a portion of a CMP system 100 is shown in FIG. 1. The portion of the CMP system 100 shows a platen 102 supporting a polishing pad 104. The platen 102 may be configured to rotate in a first direction about first rotational axis 112. A polishing pad 104 may be in face sharing contact with the platen and may be rotated by the platen. A wafer holder 106 may be configured to hold a wafer, substrate or other polishing object in an orientation to bring a layer to be removed/planarized in face sharing contact with polishing pad 104. Wafer holder 106 may be configured to rotate about axis 114, thereby also rotating the polishing object. The platen 102 and wafer holder 106 may be configured to rotate in the same direction. Wafer holder 106 may be further configured to bring the polishing object in contact with polishing pad 104 with a controlled contact pressure. A supply system 108 may be configured to deliver a polishing composition 110 to a surface of polishing pad 104 at a controlled flow rate. In this way the polishing composition 110 may be distributed to an interface between the polishing object and polishing pad 104. The polishing composition may have a pH greater than or equal to 7 and may include polishing abrasive particles with a positive surface charge. The positive surface charge may be imparted by a metal cation and/or metal hydroxide cation at least partially covering a surface of the polishing abrasive particle and imparting a positive charge. The polishing abrasive particles may physically wear away a surface layer of the polishing object.

The polishing composition, such as polishing composition 110, may be an aqueous composition including water, polishing abrasive particles and a water soluble metal salt. The polishing composition may have a pH greater than or equal to 7. The polishing abrasive particles may be nanoparticles. As one example, the polishing abrasive particles are polishing abrasive nanoparticles. The polishing composition may be prepared by containing a colloidal suspension described later including polishing abrasive nanoparticles. As one example, a mean particle diameter of the polishing abrasive nanoparticles may be more than 10 nm. A value measured as a volume mean particle diameter by a dynamic light scattering method with a particle diameter distribution measurement apparatus (UPA-UT151, manufactured by Nikkiso Co., Ltd.) may be adopted as a mean particle diameter of the polishing abrasive particles.

As one example, a mean particle diameter of the polishing abrasive nanoparticles may be more than 20 nm. As one example, a mean particle diameter of the polishing abrasive nanoparticles may be more than 30 nm. As one example, a mean particle diameter of the polishing abrasive nanoparticles may be more than 50 nm. As one example, a mean particle diameter of the polishing abrasive nanoparticles may be less than 250 nm. As one example, a mean particle diameter of the polishing abrasive nanoparticles may be less than 200 nm. As one example, a mean particle diameter of the polishing abrasive nanoparticles may be less than 150 nm. As one example, a mean particle diameter of the polishing abrasive nanoparticles may be less than 120 nm. As one example, a mean particle diameter of the polishing abrasive nanoparticles may be less than 100 nm. As one example, a mean particle diameter of the polishing abrasive nanoparticles may be in the range of 10 nm to 250 nm. As one example, a mean particle diameter of the polishing abrasive nanoparticles may be in the range of 10 nm to 200 nm. As one example, a mean particle diameter of the polishing abrasive nanoparticles may be in the range of 15 nm to 150 nm. As one example, a mean particle diameter of the polishing abrasive nanoparticles may be in the range of 20 nm to 120 nm. As one example, a mean particle diameter of the polishing abrasive nanoparticles may be in the range of 30 nm to 100 nm. As one example, a mean particle diameter of the polishing abrasive nanoparticles may be in the range of 35 nm to 90 nm. As one example, a mean particle diameter of the polishing abrasive nanoparticles may be in the range of 50 nm to 80 nm. As one example, a mean particle diameter of the polishing abrasive nanoparticles may be about 70 nm. Herein, “about X” (X is a numerical value) can mean that ±10% or ±5% of X is further included, and ±10%, as an example, means X×0.9 to X×1.1. In addition, “about X” may also be X itself.

The polishing abrasive particles may be particles having a hardness greater than a hardness of the substrate being planarized. Additionally or alternatively, the polishing abrasive particles may be formed by one or more of inorganic material, organic material, and organic-inorganic composite material. Examples thereof include the abrasive formed of any of the following: oxide such as alumina, fumed silica, colloidal silica, titania, ceria, zirconia, chromium oxide, magnesium oxide, manganese dioxide, zinc oxide, iron oxide; nitride such as silicon nitride and boron nitride; carbide such as silicon carbide and boron carbide; diamond; and carbonates such as calcium carbonate and barium carbonate; particles coated therewith; composites thereof, mixtures thereof. For example, the polishing abrasive particles may be silica particles. As one example, a proportion of the silica particles (preferably colloidal silica) in the polishing abrasive particles is 80% by mass or more, 85% by mass or more, 90% by mass or more, 95% by mass or more, or 99% by mass or more (upper limit: 100% by mass).

The polishing abrasive particles may have a surface charge as measured by zeta potential. Zeta potential of the abrasive can be measured by a Zetasizer™ manufactured by Malvern. The abrasive particles may be cationic modified particles and/or may have a positive zeta potential. The cationization may be caused by adsorption of the metal cation of the water soluble metal salt onto a surface of the polishing abrasive particle. In one example, the polishing abrasive particles may be cationic modified silica particles. The positive zeta potential may indicate the propensity of the particles to be attracted to negative surface, such as polishing surface thereby increasing a polishing speed and effectiveness of the polishing abrasive particles.

The metal salt may be a water soluble salt at the pH of the polishing composition. The water soluble metal salt may hydrolyze at the pH of the polishing composition to form a metal hydroxide. The water-soluble metal salt may be one of the salts formed from a metal ion (cation) and an anion, which is soluble in water at 25° C. at a concentration of 0.001 mol % or more, 0.01 mol % or more, or 0.1 mol % or more.

As one example, the metal cation of the water soluble metal salt may be a large metal cation. For example, a crystal radius of the metal cation may be greater than 85 pm. In some examples, a crystal radius of the metal cation may be greater than 86 pm. In some examples, a crystal radius of the metal cation may be greater than 90 pm. In some examples, a crystal radius of the metal cation may be greater than 95 pm. In some examples, a crystal radius of the metal cation may be greater than 100 pm. The large metal cation may have a lower hydration energy than a smaller metal cation. Herein, the crystal radius may be a value cited from values disclosed in Shannon, R. D., Acta Crystallogr. A32, 751, 1976. A lower hydration energy may increase the ability of the metal cation to localize on a surface of the polishing abrasive particle. Examples thereof include a nitrate, a nitrite, a sulfate and a chloride. In one example, the water soluble metal salt may be a nitrate. In some examples the metal cation of the water soluble metal salt may be an alkaline earth metal and/or a lanthanide. In some examples the metal cation of the water soluble metal salt may be a transition metal. In some examples, the metal cation of the water soluble metal salt may be one or more of a lanthanum cation, strontium cation. In some examples, the metal cation of the water soluble metal salt may be one or more of a scandium cation, a yttrium cation, a copper cation, a zinc cation, a nickel cation, a cobalt cation, and a manganese cation. In some examples, the metal cation of the water soluble metal salt may be one or more of lanthanum cation, strontium cation, and magnesium cation. For example, the water soluble metal salt may be one or more of lanthanum nitrate, strontium nitrate, and magnesium nitrate.

FIG. 2 shows an illustration of a non-functionalized polishing abrasive particle 202. When suspended in an aqueous environment, such as a polishing composition, a polishing abrasive particle 204 may be surrounded by water molecules forming a sphere of hydration 206 around the polishing abrasive particle 206. Sphere of hydration 206 may stabilize the polishing abrasive particle and there may be an energy barrier associated with breaking the sphere of hydration 206.

A water soluble metal salt may be added to the aqueous environment, thereby introducing a metal cation (Mⁿ⁺). If a pH of the aqueous environment is above a threshold level, the metal cation may be hydrolyzed in to form a metal hydroxide 210 (M(OH)^{[n-1]+}).

The metal hydroxide 210 may break the sphere of hydration 206 to form a cationized polishing abrasive particle 208 and at least partially cover a surface of the polishing abrasive particle 204. The cationized polishing abrasive particle 208 may include the metal hydroxide 210 adsorbed to a surface of the polishing abrasive particle 204 to impart a positive surface charge, observed as positive zeta potential.

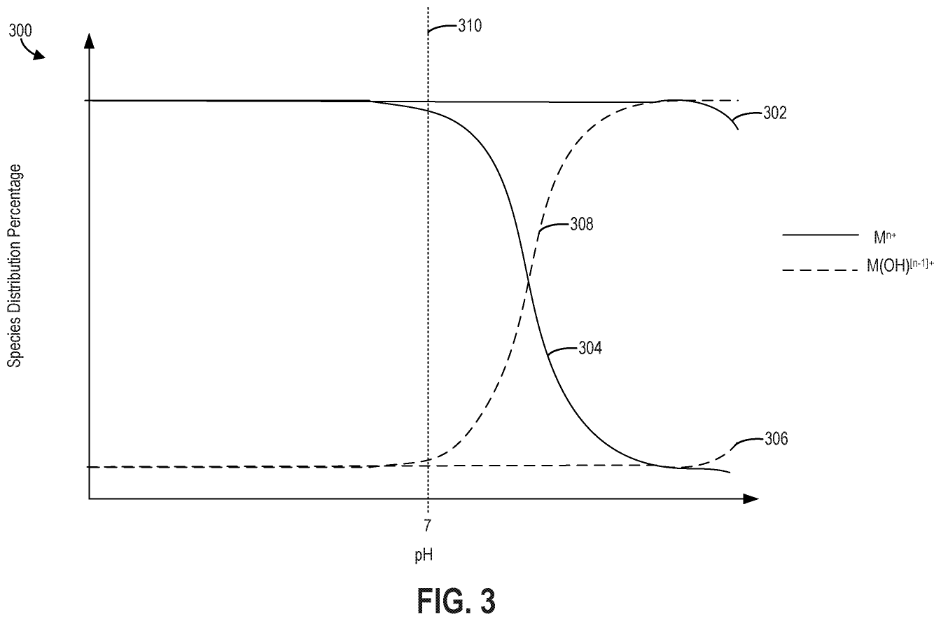

As discussed above, the water soluble metal salt may hydrolyze to form a metal hydroxide at a pH of the polishing composition. Different metal salts may hydrolyze at different pHs as shown in speciation graph 300 of FIG. 3. The speciation graph 300 plots a species distribution percentage as function of pH. Trace 302 corresponds to a percentage of a first metal cation of the metal salt as Mⁿ⁺. Trace 304 corresponds to a percentage of a second metal cation of the metal salt as Mⁿ⁺. Trace 306 corresponds to the first metal cation present as the metal hydroxide M(OH)^{[n-1]+}. Trace 308 corresponds to the second metal cation present as the metal hydroxide M(OH)^{[n-1]+}. As shown in graph 300, as pH increases a percent of the metal cation present as the metal hydroxide increases. A line 310 indicates pH 7 along the x-axis of graph 300. Both the first metal cation and second metal cation form metal hydroxide species above pH 7 and may be used in a polishing composition for cationization of a polishing abrasive particle.

As discussed above, a polishing abrasive particle cationized by a metal cation may have a positive surface charge when a pH of the polishing composition is greater than or equal to 7. FIG. 4 shows a graph 400 of zeta potential of the polishing abrasive particles as function of pH. A first trace 402 corresponds to the polishing abrasive particles without the water soluble metal salt (e.g., non-functionalized). A second trace 404 corresponds to the zeta potential of the polishing abrasive particles with the metal salt. Line 406 shows the position of pH 7 along the x-axis of graph 400. As shown in graph 400, the water soluble metal salt of the polishing composition described above increases a zeta potential of the polishing abrasive as pH increases. In this way, a zeta potential of the polishing abrasive particle with the water soluble metal salt is positive when the pH is above seven. This positive zeta potential at pH greater than 7 does not occur in the polishing abrasive particles without the metal salt because zeta potential decreases as the pH increases. The positive zeta potential may be preferred for providing stronger attraction between the polishing abrasive particle and substrate which has a neutral or negative surface charge at a pH greater than or equal to 7.

As one example, a polishing abrasive particle cationized by a metal cation may have a positive surface charge when a pH of the polishing composition is greater than or equal to 7. For example, a pH of the polishing composition may be equal to 7. In some examples, the pH of the polishing composition may be great than 7. In some examples, the pH of the polishing composition may be greater than 8. In some examples, the pH of the polishing composition may be greater than 9. In some examples, the pH of the polishing composition may be greater than 10. In some examples, the pH of the polishing composition may be greater than 11. In some examples, the pH of the polishing composition is greater than or equal to 6, greater than or equal to 6.5, greater than or equal to 7, greater than or equal to 8, greater than or equal to 8.5, greater than or equal to 9, greater than or equal to 9.5, greater than or equal to 10, or greater than or equal to 10.5. In some examples, the pH of the polishing composition is less than or equal to 14, less than or equal to 13, less than or equal to 12, less than or equal to 11.5, less than or equal to 11, less than or equal to 10.5, less than or equal to 10, less than or equal to 9.5, less than or equal to 9, less than or equal to 8.5, less than or equal to 8, less than or equal to 7.5, or less than or equal to 7. In some examples, the pH of the polishing composition is greater than or equal to 6 and less than or equal to 14, or greater than or equal to 7 and less than or equal to 11. In some examples, the pH of the polishing composition is 7 to 9. In some examples, the pH of the polishing composition is 10 to 11. Herein, the pH may be measured as follows. Specifically, the pH of each composition is measured as the value obtained after using a glass electrode-type pH meter (Model F-23, manufactured by Horiba, Ltd.), calibrating it at three points with standard buffer solutions (phthalate pH buffer, pH 4.01 (25° C.); neutral phosphate pH buffer, pH 6.86 (25° C.); carbonate pH buffer, pH 10.01 (25° C.)), and then immersing the glass electrode in each liquid and waiting for at least 2 minutes until the reading becomes stable.

In one example, zeta potential of polishing abrasive particles in the polishing composition may be greater than 0 mV. In some examples, the zeta potential of polishing abrasive particles in the polishing composition may be greater than 10 mV. In some examples, the zeta potential of polishing abrasive particles in the polishing composition may be greater than 15 mV. In some examples, the zeta potential of polishing abrasive particles in the polishing composition may be greater than 20 mV. In some examples, the zeta potential of polishing abrasive particles in the polishing composition may be greater than 30 mV. In some examples, the zeta potential of polishing abrasive particles in the polishing composition may be greater than 40 mV. In some examples, the zeta potential of polishing abrasive particles in the polishing composition is greater than 0 mV, 2 mV or greater, 5 mV or greater, 10 mV or greater, 13 mV or greater, 16 mV or greater, 19 mV or greater, 20 mV or greater, 22 mV or greater, 25 mV or greater, 28 mV or greater, 31 mV or greater, 34 mV or greater, 37 mV or greater, 40 mV or greater, 43 mV or greater, 46 mV or greater, 49 mV or greater, or 51 mV or greater. In some examples, the zeta potential of polishing abrasive particles in the polishing composition is 70 mV or less, 65 mV or less, 60 mV or less, 55 mV or less, 50 mV or less, 45 mV or less, 40 mV or less, 35 mV or less, 30 mV or less, 25 mV or less, 20 mV or less, 15 mV or less, 10 mV or less, or 5 mV or less. In some examples, the zeta potential of polishing abrasive particles in the polishing composition is greater than 0 mV and 70 mV or less, or 2 mV or greater and 55 mV or less.

Hereinafter, the description about Tables 1 and 2 is made.

### (Preparation of Pre-Polishing Solution)

First, aluminum nitrate (Al(NO₃)₃·9H₂O), lanthanum nitrate (La(NO₃)₃·6H₂O), strontium nitrate (Sr(NO₃)₂), and magnesium nitrate (Mg(NO₃)₂·6H₂O) were prepared as water soluble metal salts. Each of the water soluble metal salts was dissolved in water to prepare a pre-polishing solution. Specifically, the amount (% by mass) of the metal salt per 100 g of the pre-polishing solution and the amount of the metal salt in moles contained in the same 100 g were adjusted to be as shown in the “Wt-%” and “Moles” columns in Table 1.

### (Adjustment of pH of Pre-Polishing Solution)

Subsequently, a pH adjuster was mixed with each pre-polishing solution to adjust the pH of each pre-polishing solution. When the pH was to be increased, potassium hydroxide (KOH) was used, and when the pH was to be decreased, nitric acid (HNO₃) was used. In the aluminum system, with respect to the pH of the colloidal suspension formed by adding the silica polishing abrasive particles described below, the sample having a pH of 3.5 was left unadjusted, nitric acid (HNO₃) was added to the sample having a pH of less than 3, and KOH was added to the sample having a pH of 4. In the lanthanum, strontium, and magnesium systems, the pH of the colloidal suspension formed by adding the silica polishing abrasive particles described below was adjusted with potassium hydroxide (KOH) so as to reach the pH (the target pH) shown in Table 2.

### (Preparation of Colloidal Suspension)

Subsequently, polishing abrasive particles (colloidal silica having a mean particle diameter of 70 nm) and the pre-polishing solution were mixed to form a colloidal suspension.

The concentration of the polishing abrasive particles is as shown in the column “SS-FA (pure particle),” and the ratio of moles of metal cation to grams of the polishing abrasive particles is as shown in the column “Ratio metal cation [M]/abrasive (g).”

TABLE 1

| | |
|---|---|
| Wt-% | Moles |

Aluminum nitrate nonahydrate
Mw = 375 g/mol (Al³⁺ = 27 g/mol)

| | | |
|---|---|---|
| Metal Salt | 1.203 | 0.0032 |
| SS-FA (pure particle) | 0.2 | — |

| | |
|---|---|
| pH adjustor | No pH adjustor for pH 3.5 |
| | Nitric acid to pH < 3 |
| | KOH to pH 4 |
| Ratio metal cation [M]/ | 0.016 moles [Al³⁺] per gram pure |
| abrasive (g) | particle |

Lanthanum (III) nitrate hexahydrate
Mw = 433 g/mol (La³⁺ = 139 g/mol)

| | | |
|---|---|---|
| Metal salt | 3.89 | 0.0089 |
| SS-FA (pure particle) | 0.69 | — |

| | |
|---|---|
| pH adjustor | KOH to target pH |
| Ratio metal cation [M]/ | 0.013 moles [La³⁺] per gram pure |
| abrasive (g) | particle |

Strontium nitrate
Mw = 212 g/mol (Sr²⁺ = 88 g/mol)

| | | |
|---|---|---|
| Metal salt | 9.423 | 0.044 |
| SS-FA (pure particle) | 4 | — |

| | |
|---|---|
| pH adjustor | KOH to target pH |
| Ratio metal cation [M]/ | 0.011 moles [Sr²⁺] per gram pure |
| abrasive (g) | particle |

Magnesium nitrate hexahydrate
Mw = 256 g/mol (Mg²⁺ = 24 g/mol)

| | | |
|---|---|---|
| Metal salt | 2.3 | 0.009 |
| SS-FA (pure particle) | 0.69 | — |

| | |
|---|---|
| pH adjustor | KOH to target pH |
| Ratio metal cation [M]/ | 0.013 moles [Mg²⁺] per gram pure |
| abrasive (g) | particle |

Table 2 below shows the zeta potential of the silica polishing abrasive particles in each colloidal suspension obtained by the method described above. The details are described below. Table 2 below compares measured zeta potential for exemplary silica polishing abrasive particles in an aqueous suspension without functionalization as a control to silica polishing abrasive particles modified by different water soluble metal salts in the aqueous suspension. Zeta potential is measured by Malvern Zetasizer™. The exemplary silica polishing abrasive particles in an aqueous suspension without functionalization, used as a control, are also colloidal silica having a mean particle diameter of 70 nm. A (-) in the table indicates the zeta potential was not measured at the given pH. Suspensions which showed some precipitation of metal species or other forms of particle instability are marked as “ins.”

TABLE 2
Zeta potential of silica particles with and without metal cations with varied pH

| Cation | OH | Zeta potential (mV) | | | | | | | | | |
|---|---|---|---|---|---|---|---|---|---|---|---|
| (crystal | onset | | pH | pH | | | | | | pH | pH |
| radius) | pH | pH 2 | 2.7 | 3.5 | pH 4 | pH 5 | pH 6 | pH 7 | pH 9 | 10 | 11 |
| Al³⁺ | ~3 | 9 | 12 | 24 | 58 | ins. | ins. | ins. | ins. | ins. | ins. |
| (68 pm) | | | | | | | | | | | |
| La³⁺ | ~7 | — | — | — | — | — | 15 | 41 | 51 | ins. | ins. |
| (117 pm) | | | | | | | | | | | |
| Mg²⁺ | ~9.5 | — | — | — | — | — | — | −6 | −1 | ins. | ins. |
| (86 pm) | | | | | | | | | | | |
| Sr²⁺ | ~11 | — | — | — | — | — | — | −2 | — | 4 | 25 |
| (132 pm) | | | | | | | | | | | |
| Ctrl | n/a | 9 | 5 | 0 | −5 | −10 | −20 | −32 | −45 | −45 | −45 |

As shown in Table 2, without functionalization, the control silica particle has an isoelectric point at a pH of about 3.5, below which the zeta potential is positive and above which the zeta potential is negative. As further shown in Table 2, lanthanum cations may impart a positive surface charge on the silica even before onset of metal hydroxide formation at pH 7. Without being bound by theory, the large crystal radius of the lanthanum ion, magnesium ion, and strontium ion (in particular, lanthanum ion, strontium ion) may lower the energy hydration enough that some metal cations are adsorbed to the surface, even without first forming the metal hydroxide. As is further shown in Table 2, the zeta potential of the silica particle with lanthanum cations and strontium cations increases significantly more above the hydroxide onset pH. Further, magnesium cations and strontium cations may also increase a zeta potential of the silica particles at pH above pH 7. In some examples, a crystal radius of the cation of the water soluble metal salt is 85 pm or greater, 90 pm or greater, 95 pm or greater, 100 pm or greater, 105 pm or greater, 110 pm or greater, 115 pm or greater, 120 pm or greater, 125 pm or greater, or 130 pm or greater. In some examples, the crystal radius of the cation of the water soluble metal salt is 150 pm or less, 140 pm or less, or 135 pm or less. In some examples, the crystal radius of the cation of the water soluble metal salt is 85 pm or greater and 150 pm or less, 100 pm or greater and 140 pm or less, or 130 pm or greater and 135 pm or less. In some examples, a pH of the colloidal suspension is greater than or equal to 6, greater than or equal to 6.5, greater than or equal to 7, greater than or equal to 8, greater than or equal to 8.5, greater than or equal to 9, greater than or equal to 9.5, greater than or equal to 10, or greater than or equal to 10.5. In some examples, the pH of the colloidal suspension is less than or equal to 14, less than or equal to 13, less than or equal to 12, less than or equal to 11.5, less than or equal to 11, less than or equal to 10.5, less than or equal to 10, less than or equal to 9.5, less than or equal to 9, less than or equal to 8.5, less than or equal to 8, less than or equal to 7.5, or less than or equal to 7. In some examples, the pH of the colloidal suspension is greater than or equal to 6 and less than or equal to 14, or greater than or equal to 7 and less than or equal to 11. In some examples, the pH of the colloidal suspension is 7 to 9, or 10 to 11. In some examples, a zeta potential of the polishing abrasive particles in the colloidal suspension is −5 mV or greater, greater than 0 mV, 2 mV or greater, 5 mV or greater, 10 mV or greater, 13 mV or greater, 16 mV or greater, 19 mV or greater, 20 mV or greater, 22 mV or greater, 25 mV or greater, 28 mV or greater, 31 mV or greater, 34 mV or greater, 37 mV or greater, 40 mV or greater, 43 mV or greater, 46 mV or greater, 49 mV or greater, or 51 mV or greater. In some examples, the zeta potential of the polishing abrasive particles in the colloidal suspension is 70 mV or less, 65 mV or less, 60 mV or less, 55 mV or less, 50 mV or less, 45 mV or less, 40 mV or less, 35 mV or less, 30 mV or less, 25 mV or less, 20 mV or less, 15 mV or less, 10 mV or less, or 5 mV or less. In some examples, the zeta potential of the polishing abrasive particles in the colloidal suspension is greater than 0 mV and 70 mV or less, or 2 mV or greater and 55 mV or less. In some examples, a colloidal suspension is provided which includes a metal cation, wherein the metal cation is a lanthanum cation, wherein a pH of the colloidal suspension is 7 to 9, and wherein a zeta potential of the polishing abrasive particles is 20 mV or greater, 22 mV or greater, 25 mV or greater, 28 mV or greater, 31 mV or greater, 34 mV or greater, 37 mV or greater, or 40 mV or greater when the pH of the colloidal suspension is 7. In some examples, a colloidal suspension is provided which includes a metal cation, wherein the metal cation is a lanthanum cation, wherein a pH of the colloidal suspension is 7 to 9, and wherein a zeta potential of the polishing abrasive particles is 50 mV or less, or 45 mV or less when the pH of the colloidal suspension is 7. In some examples, a colloidal suspension is provided which includes a metal cation, wherein the metal cation is a lanthanum cation, wherein a pH of the colloidal suspension is 7 to 9, and wherein a zeta potential of the polishing abrasive particles is 20 mV or greater and 50 mV or less when the pH of the colloidal suspension is 7. In some examples, a colloidal suspension is provided which includes a metal cation, wherein the metal cation is a lanthanum cation, wherein a pH of the colloidal suspension is 7 to 9, and wherein a zeta potential of the polishing abrasive particles is 40 mV or greater, 43 mV or greater, 46 mV or greater, 49 mV or greater, or 51 mV or greater when the pH of the colloidal suspension is 9. In some examples, a colloidal suspension is provided which includes a metal cation, wherein the metal cation is a lanthanum cation, wherein a pH of the colloidal suspension is 7 to 9, and wherein a zeta potential of the polishing abrasive particles is 70 mV or less, 65 mV or less, 60 mV or less, or 55 mV or less when the pH of the colloidal suspension is 9. In some examples, a colloidal suspension is provided which includes a metal cation, wherein the metal cation is a lanthanum cation, wherein a pH of the colloidal suspension is 7 to 9, and wherein a zeta potential of the polishing abrasive particles is 40 mV or greater and 70 mV or less when the pH of the colloidal suspension is 9. In some examples, a polishing composition is provided which includes the colloidal suspension described above.

FIG. 5 shows a flow chart of a method 500 for preparing a colloidal suspension of the polishing abrasive particles and for forming a polishing composition therefrom. The polishing composition may be used with a CMP system, such as the CMP system shown in FIG. 1.

At 502, method 500 includes dissolving the water soluble metal salt in water to prepare a pre-polishing solution. Dissolving may include agitating the metal salt and water by methods such as, but not limited to, stirring, vortexing, and sonicating. Dissolving may solubilize the water soluble metal salt to form an aqueous metal cation and an aqueous anion from the water soluble metal salt.

A concentration of the water soluble metal salt may be selected to reach a desired ratio of metal cations to polishing abrasive particles. As one example, a ratio of moles of metal cation to grams of polishing abrasive particle may be in a range of 0.0001 moles/gram to 0.1 moles/gram. In some examples, the range may be 0.0005 moles/gram to 0.08 moles/gram. In some examples, the range may be between 0.001 moles/gram to 0.05 moles/gram. In some examples, the range may be 0.09 moles/gram to 0.25 moles/gram.

At 504, method 500 includes adjusting a pH of the pre-polishing solution to greater than or equal to 7. Adjusting pH may include mixing a pH adjuster into the pre-polishing solution. Further, adjusting may include adding the pH adjuster while monitoring a pH of the pre-polishing solution. Mixing may include agitating the pre-polishing solution to fully dissolve and/or incorporate the pH adjuster into the pre-polishing solution. The water soluble metal salt may stay in solution after the pH is adjusted. After adjusting the pH, the pre-polishing solution may not include a precipitate of the water soluble metal salt. Adjusting pH may cause cations of the water soluble metal salts to at least partially form metal hydroxides. As the pH adjuster used to adjust the pH of the pre-polishing solution and the colloidal suspension, one or more of the pH adjusters for polishing compositions listed below may be appropriately selected.

The pH adjuster may be an acid or base included to adjust a pH of the polishing composition to a level which is greater than or equal to 7.0. The pH adjuster may be an acid or base, depending on if adjustment is to increase or decrease pH. As one example the pH adjuster may be an inorganic acid such as sulfuric acid, nitric acid, boric acid, phosphoric acid, or the like. As a further example, the pH adjuster may be an organic acid such as carboxylic acids, organic sulfuric acids, or the like. As an additional example, the pH adjuster may be a base, including hydroxides of an alkali metal such as potassium hydroxide. As a further example, the pH adjuster may be an amine or a quaternary ammonium salt. In some examples, the pH adjuster may be a combination two or more of the above listed acids and/or bases.

At 506, method 500 includes mixing a polishing abrasive particle and the pre-polishing solution to form a colloidal suspension. Mixing may include agitating to homogeneously disperse the polishing abrasive particles. Mixing the polishing abrasive particles and the pre-polishing solution may result in metal cations of the water soluble salt adsorbing to a surface of the polishing abrasive particle and imparting a positive surface charge, measurable as a positive zeta potential of the polishing abrasive particle. In this way, the metal cation may functionalize a surface of the polishing abrasive particle to increase the zeta potential of the polishing abrasive particle.

At 508, method 500 includes mixing the colloidal suspension and a polishing composition stock to from a polishing composition having a pH greater than or equal to 7. The term “polishing composition stock” refers to the components of the polishing composition excluding the components that constitute the colloidal suspension. The components constituting the polishing composition stock may be appropriately selected depending on the type of the substrate, the purpose of polishing, and the like, and, in general, at least one selected from the group consisting of a pH adjuster and a preservative may be added. As the pH adjuster, the same ones as those disclosed herein can be used. While a pH adjuster may be added in order to prepare the pre-polishing solution (colloidal suspension), another pH adjuster may also be added separately in preparing the polishing composition. The pH adjuster of the pre-polishing solution (colloidal suspension) may be the same as or different from the pH adjuster of the polishing composition. In some examples, the pre-polishing solution (colloidal suspension) does not include an antifungal agent (antiseptic agent) and the polishing composition includes an antifungal agent (antiseptic agent). The antifungal agent (antiseptic agent) is not particularly limited, and may be appropriately selected depending on the desired application and purpose. Specific examples include isothiazoline-based antiseptic agents such as 1,2-benzisothiazol-3(2H)-one(BIT), 2-methyl-4-isothiazolin-3-one and 5-chloro-2-methyl-4-isothiazolin-3-one, and phenoxyethanol. When the polishing composition includes the antifungal agent (antiseptic agent), a content (concentration) of the antifungal agent (antiseptic agent) in the polishing composition is not particularly limited. For example, the content (concentration) of the antifungal agent (antiseptic agent) in the polishing composition is preferably 0.0001% by mass or more and 3% by mass or less, more preferably 0.001% by mass or more and 3% by mass or less, further preferably 0.01% by mass or more and less than 1% by mass based on a total mass of the polishing composition. When such a range is satisfied, a sufficient effect for deactivating or breaking microorganisms is obtained.

Mixing may include combining the colloidal suspension and polishing composition stock and agitating to homogeneously disperse the colloidal suspension throughout the polishing composition stock. Mixing may result in the cationized polishing abrasive particles suspended in the polishing composition stock to form the polishing composition. The polishing composition may have a pH greater than or equal to 7. In some examples, a pH of the polishing composition may be further adjusted after mixing the colloidal suspension and polishing composition stock to a pH greater than or equal to 7. In some examples, a pH of the colloidal suspension for the polishing composition is the same as or different from the pH of the polishing composition. In some examples, a pH adjuster of the colloidal suspension for the polishing composition is the same as or different from a pH adjuster of the polishing composition. In some examples, the polishing composition stock may be aqueous and may include additional reagents for CMP. The additional reagents may depend on the substrate and on a desired outcome of the CMP process. Method 500 ends.

The polishing composition formed at the end of method 500 may be used for CMP of a substrate having a neutral or negative surface charge at a pH greater than or equal to 7. The positive surface charge of the polishing abrasive particle may be attracted to, or at least not repelled by, the surface of the substrate. In this way, planarization of the substrate may be faster and use less polishing abrasive particles than when polishing abrasive particles have a negative surface charge at a pH of greater than or equal to 7. Examples thereof include the surface of the substrate formed of any of the following: silicon such as single crystalline silicon, polycrystalline silicon, and amorphous silicon; metal such as copper and tantalum; oxide such as TEOS and BD; carbon film; and barrier film such as ruthenium. As the substrate, one having a neutral or negative zeta potential in an environment with a pH of 7 or higher is preferred.

The technical effect of the method to produce a colloidal suspension and polishing composition therefrom which includes cationized polishing abrasive particles when a pH of the polishing composition is greater than or equal to 7. The cationized polishing abrasive particles may be attracted to a substrate being polished which has a neutral or negative surface charge. When the polishing abrasive particles are attracted to the substrate in this way, a concentration of polishing abrasive particles may be decreased and a cost of the polishing composition may be reduced.

The disclosure provides a polishing composition comprising a polishing abrasive particle and a water soluble metal salt, wherein a metal cation of the water soluble metal salt is preferably hydrolyzed at a pH≥7 without forming a precipitate. In a first example of the system, the polishing abrasive particle has a zeta potential >0. In a second example of the system, optionally including the first example, the water soluble metal salt is a nitrate. In a third example of the system, optionally including one or both of the first and second examples, the water soluble metal salt is lanthanum nitrate or strontium nitrate. In a fourth example of the system, optionally including one or more or each of the first through third examples, the polishing abrasive particle comprises cationic modified particles. In a fifth example of the system, optionally including one or more or each of the first through fourth examples, the polishing abrasive particle comprises cationic modified silica particles. In a sixth example of the system, optionally including one or more or each of the first through fifth examples, a ratio of moles of the metal cation to grams of the polishing abrasive particle is in a range of 0.0001-0.1 moles/gram. In a seventh example of the system, optionally including one or more or each of the first through sixth examples, a crystal radius of the metal cation of the water soluble metal salt is greater than 85 pm.

The disclosure also provides a colloidal suspension for a polishing composition, comprising: water, and a polishing abrasive particle, wherein a surface of the polishing abrasive particle is preferably at least partially covered by a metal hydroxide to impart a positive surface charge to the polishing abrasive particle, and wherein a pH of the colloidal suspension is ≥7. In a first example of the system, a zeta potential of the polishing abrasive particle is >0. In a second example of the system, optionally including the first example, a cation of the metal hydroxide is one or more of a lanthanum cation and a strontium cation. In a third example of the system, optionally including one or both of the first and second examples, the positive surface charge increases a zeta potential of the polishing abrasive particle. In a fourth example of the system, optionally including one or more or each of the first through third examples, a cation of the metal hydroxide is one or more of a lanthanide or an alkaline earth metal. In a fifth example of the system, optionally including one or more or each of the first through fourth examples, the polishing abrasive particle is a silicon dioxide particle.

The disclosure also provides a method for preparing a colloidal suspension for a polishing composition, comprising: dissolving a water soluble metal salt in water to prepare a pre-polishing solution, adjusting a pH of the pre-polishing solution to be ≥7, and mixing a polishing abrasive particle and the pre-polishing solution to form the colloidal suspension for the polishing composition, wherein a zeta potential of the polishing abrasive particle in the colloidal suspension is >0. In a first example of the method, a cation of the water soluble metal salt forms a metal hydroxide in the pre-polishing solution. In a second example of the method, optionally including the first example, metal hydroxide functionalizes a surface of the polishing abrasive particle in the colloidal suspension to increase the zeta potential of the polishing abrasive particle. In a third example of the method, optionally including one or both of the first and second examples, the water soluble metal salt stays in solution after adjusting the pH of the pre-polishing solution. In a fourth example of the method, optionally including one or more or each of the first through third examples, the water soluble metal salt is one or more of lanthanum nitrate and strontium nitrate. In a fifth example of the method, optionally including one or more or each of the first through fourth examples, the polishing composition is provided for polishing a substrate having a neutral or negative surface charge at a pH≥7.

The disclosure also provides a colloidal suspension for a polishing composition, comprising: water and a polishing abrasive particle, wherein a surface of the polishing abrasive particle is preferably at least partially covered by a metal cation to impart a positive surface charge to the polishing abrasive particle, and wherein a pH of the colloidal suspension is ≥7. In a first example of the system, a zeta potential of the polishing abrasive particle is >0. In a second example of the system, optionally including the first example, a metal of the metal cation is one or more of a lanthanum and a strontium. In a third example of the system, optionally including one or both of the first and second examples, the positive surface charge increases a zeta potential of the polishing abrasive particle. In a fourth example of the system, optionally including one or more or each of the first through third examples, a metal of the metal cation is one or more of a lanthanide or an alkaline earth metal. In a fifth example of the system, optionally including one or more or each of the first through fourth examples, the polishing abrasive particle is a silicon dioxide particle.

The disclosure also provides a method for preparing a colloidal suspension for a polishing composition, comprising: dissolving a water soluble metal salt in water to prepare a pre-polishing solution, adjusting a pH of the pre-polishing solution to be ≥7, and mixing a polishing abrasive particle and the pre-polishing solution to form the colloidal suspension for the polishing composition, wherein a zeta potential of the polishing abrasive particle in the colloidal suspension is >0. In a first example of the method, a cation of the water soluble metal salt preferably forms a metal hydroxide in the pre-polishing solution. In a second example of the method, optionally including the first example, a cation of the metal salt functionalizes a surface of the polishing abrasive particle in the colloidal suspension to increase the zeta potential of the polishing abrasive particle. In a third example of the method, optionally including one or both of the first and second examples, the water soluble metal salt stays in solution after adjusting the pH of the pre-polishing solution. In a fourth example of the method, optionally including one or more or each of the first through third examples, the water soluble metal salt is one or more of lanthanum nitrate and strontium nitrate. In a fifth example of the method, optionally including one or more or each of the first through fourth examples, the polishing composition is provided for polishing a substrate having a neutral or negative surface charge at a pH≥7.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure. The invention includes the following aspects and modes.
1. A polishing composition comprising: polishing abrasive particles and a water soluble metal salt, wherein a metal cation of the water soluble metal salt is hydrolyzed at a pH≥7 without forming a precipitate, and/or the polishing abrasive particles have a zeta potential >0 at a pH≥7.
2. The polishing composition of 1., wherein the polishing abrasive particles have a zeta potential >0.
3. The polishing composition of 1, or 2., wherein the water soluble metal salt is a nitrate.
4. The polishing composition of 3., wherein the water soluble metal salt is lanthanum nitrate and/or strontium nitrate.
5. The polishing composition of any of 1. to 4., wherein the polishing abrasive particles comprise cationic modified particles.
6. The polishing composition of 5., wherein the polishing abrasive particles comprise cationic modified silica particles.
7. The polishing composition of any of 1. to 6., wherein cationization of the polishing abrasive particles is caused by adsorption of the metal cation of the water soluble metal salt onto surfaces of the polishing abrasive particles.
8. The polishing composition of any of 1. to 7., wherein a ratio of moles of the metal cation to grams of the polishing abrasive particles is in a range of 0.0001-0.1 moles/gram.
9. The polishing composition of any of 1. to 8., wherein a crystal radius of the metal cation of the water soluble metal salt is greater than 86 pm.
10. The polishing composition of any of 1. to 9., wherein the water soluble metal salt is lanthanum nitrate, and wherein a pH of the polishing composition is 7 to 9.
11. The polishing composition of 10., wherein the water soluble metal salt is lanthanum nitrate, wherein a pH of the polishing composition is 7 to 9, and wherein a zeta potential of the polishing abrasive particles is 20 mV or greater when the pH of the polishing composition is 7.
12. The polishing composition of 10. or 11., wherein the water soluble metal salt is lanthanum nitrate, wherein a pH of the polishing composition is 7 to 9, and wherein a zeta potential of the polishing abrasive particles is 40 mV or greater when the pH of the polishing composition is 9.
13. The polishing composition of any of 1. to 9., wherein the water soluble metal salt is strontium nitrate.
14. The polishing composition of 13., wherein the water soluble metal salt is strontium nitrate, and wherein a pH of the polishing composition is 10 to 11.
15. A colloidal suspension for a polishing composition, comprising: water and polishing abrasive particles, wherein surfaces of the polishing abrasive particles are at least partially covered by a metal cation to impart a positive surface charge to the polishing abrasive particles, and/or a colloidal suspension for a polishing composition, comprising: water, polishing abrasive particles and a metal cation, wherein a pH of the colloidal suspension is ≥7.
16. The colloidal suspension of 15., wherein a zeta potential of the polishing abrasive particles is >0.
17. The colloidal suspension of 15. or 16., wherein a metal of the metal cation is one or more of a lanthanum and a strontium.
18. The colloidal suspension of any of 15. to 17., wherein the positive surface charge increases a zeta potential of the polishing abrasive particles.
19. The colloidal suspension of any of 15. to 18., wherein a metal of the metal cation is one or more of a lanthanide or an alkaline earth metal.
20. The colloidal suspension of any of 15. to 19., wherein the polishing abrasive particles are silicon dioxide particles.
21. The colloidal suspension of any of 15. to 20., wherein a crystal radius of the metal cation is greater than 86 pm.
22. The colloidal suspension of any of 15. to 21., wherein the metal cation is a lanthanum cation, and wherein a pH of the colloidal suspension is 7 to 9.
23. The colloidal suspension of any of 15. to 22., wherein the metal cation is a lanthanum cation, wherein a pH of the colloidal suspension is 7 to 9, and wherein a zeta potential of the polishing abrasive particles is 20 mV or greater when the pH of the colloidal suspension is 7.
24. The colloidal suspension of any of 15. to 23., wherein the metal cation is a lanthanum cation, wherein a pH of the colloidal suspension is 7 to 9, and wherein a zeta potential of the polishing abrasive particles is 40 mV or greater when the pH of the colloidal suspension is 9.
25. The colloidal suspension of any of 15. to 21., wherein the metal cation is a strontium cation.
26. The colloidal suspension of 25., wherein the metal cation is a strontium cation, and wherein a pH of the colloidal suspension is 10 to 11.
27. A method for preparing a colloidal suspension for a polishing composition, comprising: dissolving a water soluble metal salt in water to prepare a pre-polishing solution, adjusting a pH of the pre-polishing solution to be ≥7, and mixing polishing abrasive particles and the pre-polishing solution to form the colloidal suspension for the polishing composition, wherein a zeta potential of the polishing abrasive particles in the colloidal suspension is >0.
28. The method of 27., wherein a cation of the water soluble metal salt forms a metal hydroxide in the pre-polishing solution.
29. The method of 27. or 28., wherein a metal cation of the water soluble metal salt functionalizes surfaces of the polishing abrasive particles in the colloidal suspension to increase the zeta potential of the polishing abrasive particles.
30. The method of any of 27. to 29., wherein the water soluble metal salt stays in solution after adjusting the pH of the pre-polishing solution.
31. The method of any of 27. to 30., wherein the polishing composition is provided for polishing a substrate having a neutral or negative surface charge at a pH≥7.
32. The method of any of 27. to 31., wherein the water soluble metal salt is lanthanum nitrate, and wherein a pH of at least one of the colloidal suspension or the polishing composition is 7 to 9.
33. The method of 31., wherein the water soluble metal salt is lanthanum nitrate, wherein a pH of at least one of the colloidal suspension or the polishing composition is 7 to 9, and wherein a zeta potential of the polishing abrasive particles is 20 mV or greater when the pH of at least one of the colloidal suspension or the polishing composition is 7.
34. The method of 32. or 33., wherein the water soluble metal salt is lanthanum nitrate, wherein a pH of at least one of the colloidal suspension or the polishing composition is 7 to 9, and wherein a zeta potential of the polishing abrasive particles is 40 mV or greater when the pH of at least one of the colloidal suspension or the polishing composition is 9.
35. The method of any of 27. to 31., wherein the water soluble metal salt is strontium nitrate.
36. The method of 35., wherein the water soluble metal salt is strontium nitrate, and wherein a pH of at least one of the colloidal suspension or the polishing composition is 10 to 11.
37. A polishing composition, comprising: the colloidal suspension of any of 15. to 26., and a pH adjuster.
38. A method for producing a polishing composition, comprising: incorporating the colloidal suspension of any of 15 to 26 and a pH adjuster into the polishing composition.

1. A polishing composition, comprising:
polishing abrasive particles, and
a water soluble metal salt,
wherein a metal cation of the water soluble metal salt is hydrolyzed at a pH≥7 without forming a precipitate, and/or the polishing abrasive particle has a zeta potential >0 at a pH≥7.

2. The polishing composition of claim 1, wherein the polishing abrasive particles have a zeta potential >0.

3. The polishing composition of claim 1, wherein the water soluble metal salt is a nitrate.

4. The polishing composition of claim 3, wherein the water soluble metal salt is lanthanum nitrate and/or strontium nitrate.

5. The polishing composition of claim 1, wherein the polishing abrasive particles comprise cationic modified particles.

6. The polishing composition of claim 5, wherein the polishing abrasive particles comprise cationic modified silica particles.

7. The polishing composition of claim 1, wherein cationization of the polishing abrasive particles is caused by adsorption of the metal cation of the water soluble metal salt onto surfaces of the polishing abrasive particles.

8. The polishing composition of claim 1, wherein a ratio of moles of the metal cation to grams of the polishing abrasive particles is in a range of 0.0001-0.1 moles/gram.

9. The polishing composition of claim 1, wherein a crystal radius of the metal cation of the water soluble metal salt is greater than 86 pm.

10. The polishing composition of claim 1, wherein the water soluble metal salt is lanthanum nitrate, and wherein a pH of the polishing composition is 7 to 9.

11. The polishing composition of claim 1, wherein the water soluble metal salt is lanthanum nitrate, wherein a pH of the polishing composition is 7 to 9, and
wherein a zeta potential of the polishing abrasive particles is 20 mV or greater when the pH of the polishing composition is 7.

12. The polishing composition of claim 1, wherein the water soluble metal salt is lanthanum nitrate, wherein a pH of the polishing composition is 7 to 9, and
wherein a zeta potential of the polishing abrasive particles is 40 mV or greater when the pH of the polishing composition is 9.

13. The polishing composition of claim 1, wherein the water soluble metal salt is strontium nitrate.

14. The polishing composition of claim 1, wherein the water soluble metal salt is strontium nitrate, and wherein a pH of the polishing composition is 10 to 11.
